(19) United States
(12) Patent Application Publication
(10) Pub. No.: US 2005/0090239 A1
(43) Pub. Date: Apr. 28, 2005

(54) TEXT MESSAGE BASED MOBILE PHONE CONFIGURATION SYSTEM

(76) Inventors: Chang-Hung Lee, Yun-Lin Hsien (TW); Shu-Yi Chen, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,741

(22) Filed: Oct. 22, 2003

(51) Int. Cl. H04M 3/00; H04Q 7/20

(52) U.S. Cl. 455/418; 455/419; 455/466

(57) ABSTRACT

A computer is connected to a base station through a server and several networks. A web page on the computer is utilized to set configuration data of a mobile phone. The server receives the configuration data from the computer and communicates the configuration data to a base station. The base station transmits the configuration data to the mobile phone as a text message. The mobile phone is responsive to the configuration data and adjusts its operating configuration accordingly. The mobile phone includes a parser controlled by a processor for parsing the text message, the parser outputting parsed configuration data to the processor to effect the configuration.

### BACKGROUND OF INVENTION

1. Field of the Invention

The present invention relates to telecommunications, and more specifically, to a system for configuring a mobile phone.

2. Description of the Prior Art

Currently, mobile (wireless) phones are undergoing much development in advanced functionality. In addition to core hardware improvements such as the development of third generation (3G) wireless phones, auxiliary functionality is also undergoing great improvement. Auxiliary functions typically include such things as: phone books, ring tones, network settings, short message services, and games.

Configuring these auxiliary functions is conventionally performed in two ways. First, for minor adjustments, a user simply employs the mobile phone user interface. For example, such an adjustment could be adding a new phone book entry or setting the preferences for a game. Second, for major adjustments, which are usually beyond the capabilities of the phones user interface, a PC based system is conventionally used. The user must physically connect the mobile phone to a PC by way of a connecting cable, load configuration software onto the PC, and use the configuration software to change settings in the phone. This type of adjustment could be manipulating a menu structure or uploading a ring tone. Moreover, many major adjustments can only be performed at specialized service centers by trained personnel, as they sometimes involve use of complex or proprietary software.

Both of these methods of configuration have drawbacks. Applying the user interface is limited by the capabilities of interface itself and can be very inconvenient. For example, manipulating a menu structure with a 12-key phone key-pad may prove to be impossible, and is at the very least tiresome. Also, preventing certain functionality from being modified though the phone interface is sometimes required for security reasons. Using a PC-based application requires the user to install the application onto a PC. In some circumstances, this may be inconvenient or impossible, such as in a secure office environment where installation of outside applications is prohibited. Also, the requirement of physically connecting the phone to the PC via the cable is inconvenient.

One solution to the above drawbacks is presented in U.S. Pat. No. 6,356,543 to Hall et al., which is incorporated herein by reference. Hall et al., system employs a PC, the Internet, and a wireless network base station. A user can make changes to a mobile phones services via the PC interface. Information relating changes in services is sent from the PC through the Internet and to the base station. The base station then transmits this information, which is described as service applications, to the mobile phone. While this is an improvement over the conventional methods described above, Hall et al.'s system also has disadvantages. First, application transfer occurs over a specialized Global System for Mobile Communications (GSM) path. Such a path is not available to a majority of mobile phones, and thus these phones would not be useable in the system. Second, Hall et al.'s PC emulates the user interface of the mobile phone with the aim of customizing the look and feel. While emulating the phones user interface certainly has advantages, doing so introduces the precise limitations of the mobile phone's interface that it is desirable to avoid. Finally, Hall et al.'s system sends functional applications to the mobile phone, which is time consuming and may require waiting until the phone is not in use (i.e. late at night) to download.

As such, an improved system of configuring a mobile phone with a PC is required.

### SUMMARY OF INVENTION

It is therefore a primary objective of the claimed invention to provide a mobile phone configuration system, mobile phone, and related method that allow a user to configure a mobile phone with a PC via existing text messaging systems.

Briefly summarized, the claimed invention mobile phone configuration system includes a computer, a server connected to the computer, and a base station connected to the server. The computer is applied by a user to set configuration data of a mobile phone. The server receives the configuration data from the computer and communicates the configuration data to a base station. The base station transmits the configuration data to the mobile phone as a text message. The mobile phone is responsive to the configuration data and adjusts its operating configuration accordingly.

According to the claimed invention, a mobile phone includes a housing, a processor disposed inside the housing for controlling the mobile phone, a transmitter electrically connected to the processor for transmitting signals to a base station, a receiver electrically connected to the processor for receiving signals from the base station, an input device electrically connected to the processor for receiving user input, a display device electrically connected to the processor, and a power supply for providing electrical power to the mobile phone. The mobile phone further includes a parser controlled by the processor for parsing a text string of configuration data received at the receiver, the parser outputting the parsed configuration data to the processor. Operations of the mobile phone are governed by a configuration, and the processor is capable of adjusting the configuration of the mobile phone based on the parsed configuration data.

According to the claimed invention, a method for configuring a mobile phone includes steps of: constructing a configuration data corresponding to a target configuration of the mobile phone, wirelessly transmitting the configuration data to the mobile phone as a text message, parsing the configuration data with the mobile phone, and configuring the mobile phone based on the parsed configuration data.

According to the claimed invention, the text message is sent through an established short message service (SMS) system.

It is an advantage of the claimed invention that text message infrastructure is widely in place and new hardware and software required to implement the invention is minimal.

It is a further advantage of the claimed invention limitations in the user interface of the phone can be avoided when configuring the phone.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a mobile phone configuration system according to the present invention.

FIG. 2 is a table of configuration data according to the present invention.

FIG. 3 is a block diagram of a mobile phone according to a first embodiment of the present invention.

FIG. 4 is a block diagram of a mobile phone according to a second embodiment the present invention.

FIG. 5 is a schematic diagram of a configuration web page according to the present invention.

### DETAILED DESCRIPTION

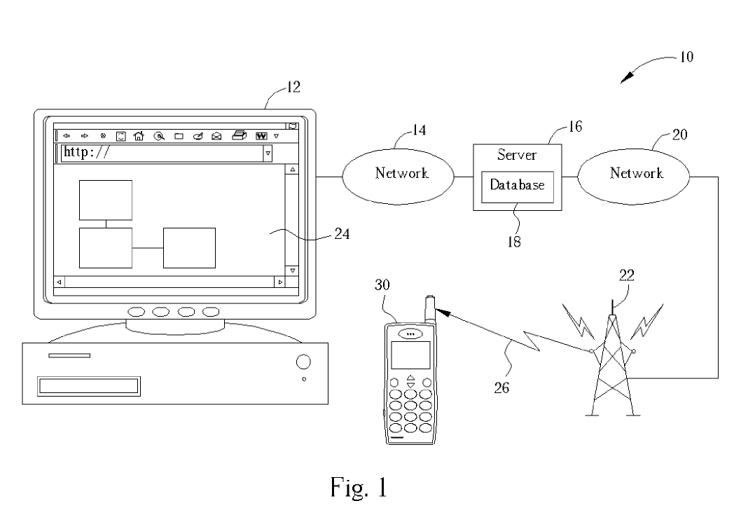

Please refer to FIG. 1 illustrating a schematic diagram of a mobile phone configuration system 10 according to the present invention. The system 10 includes a computer 12, a network 14, a server 16 storing a database 18, another network 20, a cellular base station 22, and a mobile phone 30. The network 14 connects the computer 12 to the server 16, and can be a wired or wireless local area intranet, or a larger network such as the Internet for example. The network 20 connects the server 16 to the base station 22. The network 20 can comprise a wired or wireless local area intranet, the Internet, and/or specialized mobile phone service provider systems (e.g. mobile services switching center, message center, etc). Moreover, the networks 14 and 20 can share components and can even be entirely the same network. The server 16 is a computer capable of communicating with the computer 12 and base station 22 via the networks 14 and 20 respectively, and further capable of storing and manipulating the database 18. The base station 22 is for transmitting (and receiving) information to the mobile phone 30, and specifically, for transmitting a short message service (SMS) message 26 comprising configuration information to the mobile phone 30.

The computer 12 can access a web page 24 stored on the server 16. The web page 24, which will be described in detail later, allows a user of the computer 12 to manipulate a configuration stored in the database 18 of the mobile phone 30. The database 18 stores configurations and related web page information for a plurality of users of the present invention system 10. That is, a plurality of computers 12 can be connected to the server 16 through the network 14 to change configurations of a plurality of mobile phones 30.

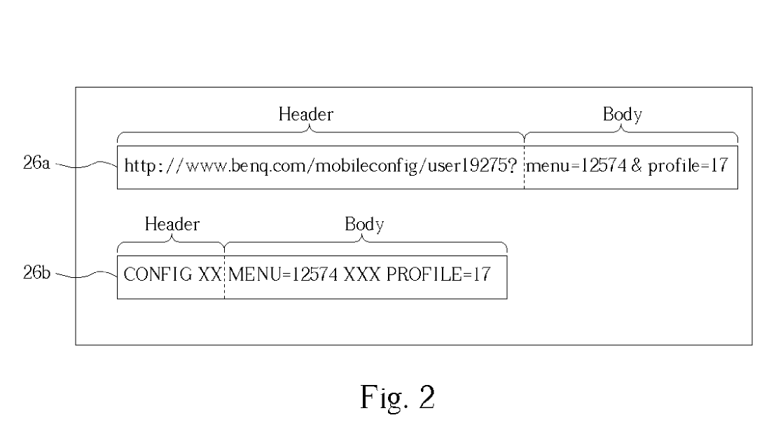

The computer 12 sends a selected configuration through the network 14, the server 16, and the network 20 to the base station 22 for transmission to the mobile phone 30 as the SMS message 26. Referring to FIG. 2, examples of the SMS configuration message 26 are illustrated. Both SMS messages 26a, 26b comprise a header and a body as indicated. The SMS message 26a follows the form of a hypertext transfer protocol link commonly used in the Internet. As such, the SMS message 26a can be formed at the computer 12 and simply forwarded to the base station 22 by the server 16. Then, the base station 22 then transmits the SMS message 26a (after shortening the header if desirable) to the mobile phone 30. The SMS message 26b follows another form in which “X” represents a placeholder. This form can be constructed at the computer 12, the server 16, or even at the base station 22. As illustrated, both SMS messages 26a, 26b instruct the mobile phone 30 to set a menu structure variable “menu=12574” and set a user profile variable “profile=17”, as examples of respectively configuring the menu structure and personal profile information of the mobile phone 30. In addition, the SMS message 26a identifies a user “user19275” of the target phone, while this information in the SMS message 26b has been trimmed. Regardless of the exact form of the SMS message 26, it must comprise recognized text characters used in common SMS systems. For example, such messages could comprise selected characters of the ASCII character set.

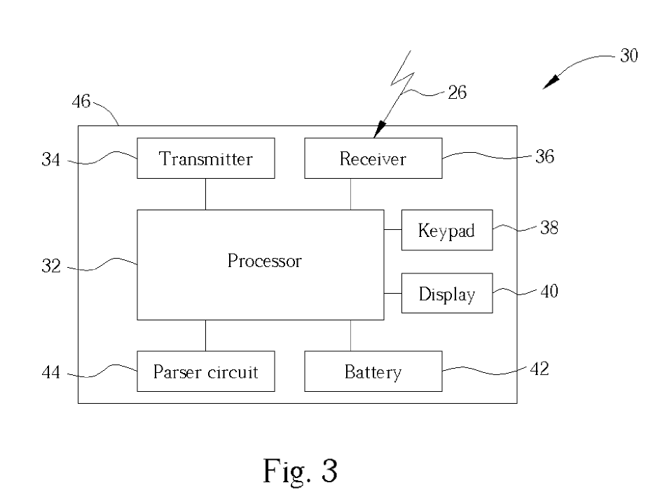

In order to successfully pass a configuration to the mobile phone 30 via the SMS message 26 (26a, 26b), the mobile phone 30 requires a parser to interpret the SMS message. FIG. 3 illustrates a block diagram of the mobile phone 30 according to the first embodiment. The mobile phone 30 includes a processor 32, a transmitter 34, a receiver 36, an input device (keypad) 38, a display 40, a battery 42, and a parser circuit 44 all contained within a housing 46. The processor 32 is connected to all components and controls all components as is well known in the art. The transmitter 34 is for transmitting call or message information to the base station 22, and the receiver 36 is for receiving call or message information from the base station 22. The keypad 38 and display 40 constitute the user interface of the mobile phone 30. The battery 42 supplies power to all components requiring it.

The parser circuit 44 is activated by the processor 32 when an SMS message having a specific header identifying it as configuration information is received by the receiver 36. That is, when a message is received at the receiver 36, the processor 32 begins to decode it in the conventional way until the processor 32 fully decodes the header (FIG. 2). Once the processor 32 decodes the header and determines that configuration information is in the body, the processor forwards the body to the parser circuit 44 rather than displaying the message to the user on the display 40. Then, the parser circuit 44 interprets the body of the message and sends instructions to the processor 32 to effect the configuration stored in the body of the message. The specific design of the parser circuit 44 depends on exactly what format is used for the SMS message 26, and is well within the skill of one familiar with digital electronics and mobile phone architecture.

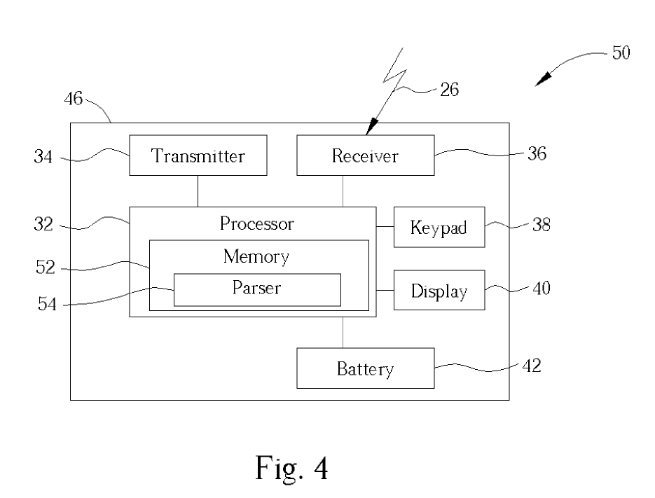

FIG. 4 illustrates a mobile phone 50 according to the second embodiment. The mobile phone 50 is identical to the mobile phone 30 except that the parser is a software parser 54 stored in a memory 52 of the processor 32. The parser 54 is code executable by the processor 32 that realizes the above functions. The memory 52 is preferably a nonvolatile memory such as a flash memory. Operation of the mobile phone 50 is the same as that of the mobile phone 30 according to the first embodiment. The specific design of the parser code 54 depends on exactly what format is used for the SMS message 26, and is well within the skill of one familiar with programming and mobile phone architecture in general.

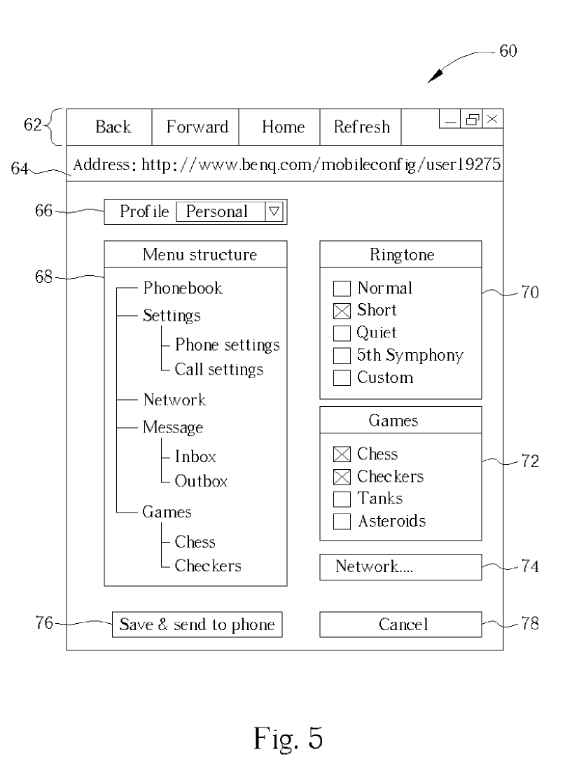

FIG. 5 is a schematic diagram of a configuration web page 60 according to the present invention. The web page 60 is an example of the previously described web page 24. The web page 60 is stored on the server 16 and available to the user on the computer 12. The web page 60 includes common features such as browser buttons 62 and an address field 64. In addition, specific to the present invention mobile phone configuration system, the web page 60 includes a profile selector 66, a menu configuration control 68, a ring tone configuration control 70, a games configuration control 72, and a network configuration button 74. It is important to note that the web page 60 is formatted in a way that is easy to use on the computer 12, rather than emulating the user interface of the mobile phone 30. That is, controls are designed and presented to overcome limitations of the user interface of the phone 30. The profile selector 66 allows the web page 60 to support multiple configurations for a given user. The menu configuration control 68 lets the user manipulate the internal menu structure of the mobile phone 30 by easy drag-and-drop functionality, for example. The ring tone control 70 allows the user to select active tones and upload or delete custom tones. Similarly, the games configuration control lets the user determine which games are present on the phone 30, and configure settings for these games. The network configuration button 74 loads a dialog box that allows the user to make changes to the operation of the mobile phone 30.

After the user modifies the mobile phone configuration presented on the web page 60, the user can save the changes to the database 18 and effect the configuration of the phone 30 by pressing a save and send button 76. At this time, an SMS message 26 of predetermined format 26a, 26b containing text codes relevant to the changes made is sent from the computer 12 or server 16 to the mobile phone 30 via the base station 22. If the user makes an error, they need only cancel changes made with a cancel button 78. Note that the address in the address field 64 is part of the SMS configuration message 26a, and subsequent configuration options need only be appended to the address when the format of the SMS message 26a is used. Naturally, any other type of SMS configuration message, such as the SMS message 26b, can be used in conjunction with the web page 60.

In contrast to the prior art, the present invention uses established text-messaging systems to pass configuration data to mobile phones. The present invention includes a computer for generating a text message containing configuration data, and a parser circuit or program in a mobile phone that interprets configuration data of effect changes on the mobile phone. Limitations in the user interface of the phone are minimized by a web page.

Those skilled in the art will readily observe that numerous modifications and alterations of the device may be made while retaining the teachings of the invention. Accordingly, the above disclosure should be construed as limited only by the metes and bounds of the appended claims.

1. A mobile phone configuration system comprising:
a computer for setting configuration data of a mobile phone;
a server connected to the computer for receiving the configuration data from the computer; and
a base station connected to the server for receiving the configuration data from the server and transmitting the configuration data to the mobile phone as a text message;
wherein the mobile phone is responsive to the configuration data and adjusts its operating configuration accordingly.

2. The mobile phone configuration system of claim 1 further comprising a network connecting the computer to the server.

3. The mobile phone configuration system of claim 2 further comprising a web page stored on the server and accessible by the computer, the web page comprising a user interface allowing setting of the configuration data.

4. The mobile phone configuration system of claim 3 wherein the configuration data is transmitted from the computer to the server and from the server to the base station as a text string.

5. The mobile phone configuration system of claim 4 wherein the text string is substantially the same as the text message.

6. The mobile phone configuration system of claim 1 further comprising a network connecting the server to the base station.

7. The mobile phone configuration system of claim 1 further comprising a database connected to the server for storing a plurality of configuration data sets that are accessible by the computer through a security system of the server.

8. The mobile phone configuration system of claim 1 wherein the test message comprises a header and a body, wherein the header identifies the text message as configuration data and the body stores the configuration data.

9. The mobile phone configuration system of claim 1 wherein the text message is an short message service (SMS) message.

10. The mobile phone configuration system of claim 1 wherein the mobile phone comprises a parser for parsing the text message into a configuration of the mobile phone.

11. A mobile phone comprising:
a housing;
a processor disposed inside the housing for controlling the mobile phone;
a transmitter electrically connected to the processor for transmitting signals to a base station;
a receiver electrically connected to the processor for receiving signals from the base station;
an input device electrically connected to the processor for receiving user input;
a display device electrically connected to the processor;
a power supply for providing electrical power to the mobile phone; and
a parser controlled by the processor for parsing a text string of configuration data received at the receiver, and outputting the parsed configuration data to the processor;
wherein operations of the mobile phone are governed by a configuration, and the processor is capable of adjusting the configuration of the mobile phone based on the parsed configuration data.

12. The mobile phone of claim 11 wherein the parser is an electronic device disposed inside the housing and electrically connected to the processor.

13. The mobile phone of claim 11 wherein the parser is a program stored in a memory of the processor and executable by the processor.

14. The mobile phone of claim 11 wherein the configuration data comprises instructions that when parsed adjust: a menu tree structure, menu contents, phone book contents, or a users personal preference information of the mobile phone.

15. The mobile phone of claim 11 wherein the processor implements the configuration of the parsed configuration data immediately upon receipt of the parsed configuration data.

16. The mobile phone of claim 11 wherein the processor implements the configuration of the parsed configuration data upon a confirmation received from the input device.

17. A method for configuring a mobile phone comprising:
constructing a configuration data corresponding to a target configuration of a mobile phone;
wirelessly transmitting the configuration data to the mobile phone as a text message;
parsing the configuration data with the mobile phone; and
configuring the mobile phone based on the parsed configuration data.

18. The method of claim 17 wherein the constructed configuration data is in the form of a text string.

19. The method of claim 18 wherein the text string is a short message service (SMS) message, the method further comprising storing the SMS message relating the configuration data at a message center when the configuration data cannot be transmitted to the mobile phone.

20. The method of claim 17 wherein constructing the configuration data comprises receiving the configuration data from a remote computer or selecting the configuration from a database.
